(19) United States
(12) Patent Application Publication
(10) Pub. No.: US 2004/0228455 A1
(43) Pub. Date: Nov. 18, 2004

(54) Dynamic range compression modification of a digital telephone switch for individual hearing characteristics

(76) Inventor: Eric M. Texley, Boca Raton, FL (US)

Correspondence Address: Eric M. Texley, 4515 NW 5th Ave., Boca Raton, FL, 33431, US

(21) Appl. No.: 10/436,421

(22) Filed: May 13, 2003

(51) Int. Cl. H04M 11/00; H04M 1/00; H04M 9/00

(52) U.S. Cl. 379/52; 379/93.08; 379/388.05

(57) ABSTRACT

A phone reception system that provides differential volume at different frequencies is made available on demand by application of a multiband dynamic range compression filter to enhance the normally audible spectrum of a signal. Audio components that lie above a person's sensitive hearing regions are amplified so that they can hear and understand them. The modifications are available on demand through a message from any remote customer premises equipment or business phone to the softswitch.

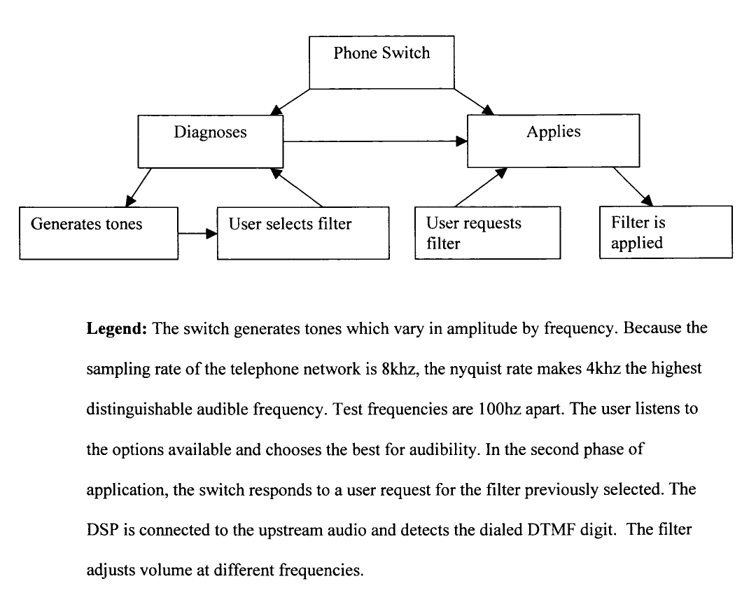

In a process analogous to presbyopic changes in vision, middle aged persons normally experience diminishing ability to discern high frequency sounds, above 2500 Hz. Typically, it will cause a person to have trouble hearing the consonants in speech. This affects understanding of human voices, especially over the telephone. Called presbyacusis, this age-related hearing loss is rarely so severe that medical devices are needed. But people resist using the phone, causing unnecessary isolation.

Just as presbyopic older adults can choose inexpensive vision aids, presbyacusic adults should be able to choose modifications of their phone service that provide more comfortable hearing. This does not normally mean a louder volume at all frequencies; that increases discomfort without addressing the proble.

This invention allows dynamic range compression of the sound produced by a public telephone switch, in a variety of frequency ranges. From these modifications, a telephone user can choose the range that is most comfortable (provides the most clarity) in normal use. The switch modification would be available to the client at any point of use, through a code entered into the phone system.

### STATEMENT REGARDING FEDERALLY SPONSORED RESEARCH OR DEVELOPMENT

This invention was not produced as the result of any federally sponsored research or development.

### BACKGROUND OF THE INVENTION

As people move through middle age, they experience minimal frequency-limited hearing loss, but seldom comprehend the mechanism or extent of the problem. Studies that test the ability of adult listeners to recognize vowel-consonant-vowel syllables demonstrate that relatively mild presbyacusis can result in significant decreases in understanding. The results of a study of 613 patients with inner ear high frequency hearing disorders found a close correlation between pure tone hearing loss above 40 dB at the frequencies 3,000, 2,000, and 1,000 Hz and their ability to discriminate among monosyllables at a speech intensity of 65 dB. In progressive high tone deafness with residual hearing in the low frequency range, correlations exist between hearing loss above 40 dB in the frequencies 500 and 250 Hz on the one hand and the ability to discriminate among monosyllables at intensity levels of 80 and 95 dB. Environmental damage to the auditory nerve or receptors in the ear can also cause a high frequency hearing loss that sometimes mimics progressive decline in old age.

These minor disabilities become especially important because certain voices vary their pitch during normal conversation and pitch is essential to understanding certain languages (such as Mandarin Chinese.) The patient loses portions of a conversation and thus meaning. This is exacerbated by the telephone receiver.

In the elderly hearing loss is also complicated by significant psychological resistance to assistive technologies. As presbyacusis progresses, social complications occur.

Hearing aids that modify specific frequencies are available. However, they are expensive, seldom covered by insurance. Magnetic interference can occur between the phone receiver and the hearing aid, causing further resistance even in those who otherwise tolerate an assistive device well. As differences in the clarity of various audible frequencies increase, people may spend less time on the phone contacting friends or relatives. They may understand the communication of males (who normally speak in lower frequency ranges) than females. As they gradually withdraw from phone contact, their mental health and safety suffer.

### BRIEF SUMMARY OF THE INVENTION

A phone reception system that provides differential volume at different frequencies is made available to a person through this invention's modification of telephone soft switching technology. This invention uses a multiband dynamic range compression filter to enhance the normally audible spectrum of a signal, so that the audio components that lie above a person's sensitive hearing regions are amplified so that they can hear and understand them. The modifications are available on demand through a message from any remote customer premises equipment or business phone to the softswitch. Therefore, a consumer who prefers a certain range of amplification can request it from his local phone company from anywhere in its region.

A filter was designed to mimic a two channel dynamic range compressor. The objective of the filter was to pass all frequencies up to a particular frequency, and then apply fixed gain from that point on. By combining several such filters, it was possible to apply varying amounts of audible gain throughout the frequency spectrum. This algorithm passes all frequencies up to a particular point, and then begin amplification. When several of these filters were overlapped, several bands of amplification of differing degrees may be constructed. The upper range of amplification begins where the subject suffers

### DETAILED DESCRIPTION OF THE INVENTION

The invention creates an all pass filter to amplify phone output at or above a given frequency, rather than the entire phone output. Several such filters can be cascaded in order to create additional modifications for a particular subject's equiloudness curve. The filters can be applied on demand through remote access to the phone switch.

This invention creates a modifier for real time audio streams. The filter applies modification to the associated audio streams beginning at a specific frequency. The modification is conveyed to the digital signal processor at the time that the call is established. The filter may be applied repeatedly, in succession, as the curve requires. Individual bands of the audio signal are amplified in a manner that is conveyed through parameterization of the audio band.

This invention differs from assistive hearing devices that provide the same frequency modification, because it is applied to a public phone switch and is available on demand from remote customer premises equipment. It provides a variety of outputs from a standard phone from which any user can choose.

A dynamic range compressor works in real time on an audio signal, applying gain to frequency bands within the signal as a function of the power in the band. In a traditional multi-band compressor, the output is a function of the power distribution of the input signal. A bandpass filter bank can divide a signal into a number of channels. Gain is applied to each channel independently as a function of the power in then channel. The filter bank is designed so that the sum of the magnitude responses of the filters is unity, so as to close the gap between the bands. The sampling rate in the system must be sufficiently high, and the input to the system prefiltered so as to eliminate artifacts:

Gb(w)=Hb(w)*f(Pb)

The gain for a given frequency band is a function of the frequency dependent power distribution of the input signal.

F(Pb) is designed such that

F(Pb)=Pb=Int(all infinity) (Hb(w)*X(w))\hat{ }2dw

Multiband Amplifier
function signalout=newway(signalin, alpha, fs, low, high)
a = 2*(low/(fs/2))−1;
b = 0.30627951;
c = 0.78214401;
nf=1024;
b2 = (b +a*a)/(1+b*a*a); Or /*
b1 = 2*a*(1+b)/(1+b*a*a);
c2 = (c +a*a)/(1+c*a*a);
c1 = 2*a*(1+c)/(1+c*a*a);
% Filter H1
% H1 = (b2*zz + b1*z + 1)./(zz + b1*z + b2);
h1n=[[(b+a\hat{ }2)/(1+b*a\hat{ }2)) ((2*a*(1+b))/(1+b*a\hat{ }2)) 1];
h1d=[1 ((2*a*(1+b))/(1+b*a\hat{ }2)) ((b+a\hat{ }2)/(1+b*a\hat{ }2))];
% Filter H2
% H2 = (c2*zz + c1*z + 1)./(zz + c1*z + c2);
% H2 = H2 * (az+1)/(z+a)
% n
%(1/(1+c*a\hat{ }2)+a\hat{ }3+a/(1+c*a\hat{ }2)*c)*z\hat{ }3+(2*a\hat{ }2/(1+c*a\hat{ }2)*c+1/(1+c*a\hat{ }2)*c+3/(1+c*a\hat{ }2)
% *a\hat{ }2)*z\hat{ }2+(2*a/(1+c*a\hat{ }2)+2*a/(1+c*a\hat{ }2)*c+a)*z+1
%>> d
%d =
%z\hat{ }3+(2*a/(1+c*a\hat{ }2)+2*a/(1+c*a\hat{ }a)*z\hat{ }2+(2*a\hat{ }2/(1+c*a\hat{ }2)*c+1/(1+c*a\hat{ }2)*c+3/(1+
%c*a\hat{ }2)*a\hat{ }2)*z+1/(1+c*a\hat{ }2)*a\hat{ }3+a/(1+c*a\hat{ }2)*c
h2n = [(1/(1+c*a\hat{ }2)*a\hat{ }3+a/(1+c*a\hat{ }2)*c) (2*a\hat{ }2/(1+c*a\hat{ }2)*c+1/(1+c*a\hat{ }2)*c+3/(1+c*a\hat{ }2)*a\hat{ }2)
(2*a/(1+c*a\hat{ }2)+2*a/(1+c*a\hat{ }2)*c+a) 1];
h2d = [1 (2*a/(1+c*a\hat{ }2)+2*a/(1+c*a\hat{ }2)*c+a) (2*a\hat{ }2/(1+c*a\hat{ }2)*c+1/(1+c*a\hat{ }2)*c+3/(1+c*a\hat{ }2)*a\hat{ }2)
1/(1+c*a\hat{ }2)*a\hat{ }3+a/(1+c*a\hat{ }2)*c];
%H = (alpha+1)*H2 + (1−alpha)*H1;
%H = 0.5*H;
h2n = .5*(alpha+1)*h2n;
h1n = .5*(1−alpha)*h1n;
% build a band stop filter for the high pass range
a = 2*(high/(fs/2))−1;
b = 0.30627951;
c = 0.78214401;
alpha = 1/alpha;
nf=1024;
b2 = (b +a*a)/(1+b*a*a);
b1 = 2*a*(1+b)/(1+v*a*a);
c2 = 2*a*(1+c)/(1+c*a*a);
% Filter H1
% H1 = (b2*zz + b1*z + 1)./(zz + b1*z + b2);
l1n=[((b+a\hat{ }2)/(1+b*a\hat{ }2)) ((2*a*(1+b)/(1+b*a\hat{ }2)) 1];
l1d=[1 ((2*a*(1+b))/(1+b*a\hat{ }2)) ((b+a\hat{ }2)/(1+b*a\hat{ }2))];
% Filter H2
% H2 = (C2*zz + c1*z + 1)./(zz + c1*z + c2);
% H2 = H2 * (az+1)/(z+a)
% n =
%(1/(1+c*z\hat{ }2)*a\hat{ }3+a/(1+c*a\hat{ }2)*c)*z\hat{ }3+(2*a\hat{ }2/(1+c*a\hat{ }2)*c+1/(1+c*a\hat{ }2)*c+3/(1+c*a\hat{ }2)
% *a\hat{ }2)*z\hat{ }2+(2*a/(1+c*a\hat{ }2)+2*a/(1+c*a\hat{ }2)*c+a)*z+1
%>> d
%d =
%z\hat{ }3+(2*a/(1+c*a\hat{ }2)+2*a/(1+c*a\hat{ }2)*c+a)*z\hat{ }2+(2*a\hat{ }2/(1+c*a\hat{ }2)*c+1/(1+c*a\hat{ }2)*c+3/(1+
%c*a\hat{ }2)*a\hat{ }2)*z+1/(1+c*a\hat{ }2)*a\hat{ }3+a/(1+c*a\hat{ }2)*c
l2n = [(1/(1+c*a\hat{ }2)*a\hat{ }3+a/(1+c*a\hat{ }2)*c) (2*a\hat{ }2/(1+c*a\hat{ }2)*c+1/(1+c*a\hat{ }2)*c+3/(1+c*a\hat{ }2)*a\hat{ }2)
(2*a/(1+c(a\hat{ }2)+2*a/(1+c*a\hat{ }2)*c+a) 1];
12d = [1 (2*a/(1+c*a\hat{ }2)+2*a/(1+c*a\hat{ }2)*c+a) (2*a\hat{ }2/(1+c*a\hat{ }2)*c+1/(1+c*a\hat{ }2)*c+3/(1+c*a\hat{ }2)*a\hat{ }2)
1/(1+c*a\hat{ }2)*a\hat{ }3+a/(1+c*a\hat{ }2)*c];
%H = (alpha+1)*H2 + (1−alpha)*H1;
%H = 0.5*H;
12n = .5*(alpha+1)*12n;
l1n = .5*(1−alpha)*11n
figure(1);
imp=zeros(1,nf);
imp(nf/2)=1;
freq=[0:(fs/2)/(nf/2):(fs/2)−(2/nf)]
output=filter(h1n,h1d,signalin);
output2=filter*h2n,h2d,signalin);
output_total=output+output2;
% now find the response to the second filter
output3 = filter(l1n,l1d,output_total);
output4 = filter(l2n,l2d,output_total);
signalout=output3+output4;
% now find the frequency response
outputf=fft(signalout);
outputf=outputf(1:nf/2);
% plot the frequency output
plot(freq,abs(outputf;);

C Implementation:

```
Filter Stuff */
int filter(long input, long n[4], long d[4], long num_mem[4], long
den_mem[4])
{
  /* Current Output */
  int y0=0;
  y0 = (n[0]*input) + (n[1]*num_mem[0]) + (n[2]*num_mem[1]) +
(n[3]*num_mem[2]) − (d[1]*den_mem[0]) − (d[2]*den_mem[1])−
(d[3]*den_mem[2]);
  /* Normalizing constant */
  y0 = y0 / d[0];
  /* Propogate values 3rd order */
  den_mem[2]=den_mem[1];
  num_mem[2]=num_mem[1];
  /* Propogate values 2nd order */
  den_mem[1]=den_mem[0];
  num_mem[1]=num_mem[0];
  /* Propogate values 1st order */
  den_mem[0]=y0;
  num_mem[0]=input;
  return(y0);
}
```

1. What I claim as my invention is the application of a specific filter (defined above) on a telephone soft switch to allow to allow auditory signals modified by dynamic range compression to go to specific customers. The specific use of the filter for the purpose of modifying phone reception for minimal high frequency hearing loss is the sole claim in this application.
